(19) United States
(12) Patent Application Publication
(10) Pub. No.: US 2012/0082479 A1
(43) Pub. Date: Apr. 5, 2012

(54) IMAGE PROCESSING DEVICE WITH LIFTABLE UPPER CASING

(76) Inventor: Katsuhiko Gotoda, Hsin-Chu Hsien (TW)

(21) Appl. No.: 13/239,377

(22) Filed: Sep. 21, 2011

(30) Foreign Application Priority Data
Oct. 4, 2010 (TW) 099133693

(51) Int. Cl. G03G 15/00

(52) U.S. Cl. 399/125

(57) ABSTRACT

An image processing device includes a base, an upper casing, an image bearing member, and an image transfer member. The upper casing is liftably disposed above the base. The image bearing member is mounted in the upper casing. The image transfer member is mounted in the base and positioned opposite the image bearing member. The image bearing member and the image transfer member transfer a toner image from the image bearing member to a recording medium passing therebetween. The image bearing member is removed from its position opposite the image transfer member as the upper casing is lifted from the base.

### BACKGROUND OF THE INVENTION

1. Field of the Invention

The present invention relates to an image processing device, and more particularly, to an image processing device with an image bearing member removable from its position opposite an image transfer member.

2. Description of the Prior Art

Generally speaking, the electrophotographic process involves the following steps: charging, exposing, developing, transferring and fusing. Please refer to FIG. 1, which is a perspective view of a multi-function printer 10 according to the prior art. The multi-function printer 10 (e.g. a laser multi-function printer) includes a printer 12 and a scanner 14. The scanner 14 is mounted above the printer 12 for scanning document sheets. The printer 12 includes an image bearing member 16 (e.g. a photosensitive drum), a writing unit 18, a developing assembly 20, an image transfer member 22 (e.g. an image transfer roller), a feeding mechanism 24 (briefly depicted by a feeding roller in FIG. 1) and a fuser 26.

Brief description of the electrophotographic process is provided as follows. At first, the writing unit 18 exposes the image bearing member 16 so as to form a latent image. Toner particles are supplied by the developing assembly 20 and adhered to the latent image of the image bearing member 16, so as to form a corresponding toner image. Next, the toner image is transferred onto a recording medium M (such as a paper sheet) from the image transfer member 22. Finally, the toner particles are fused and fixed on the recording medium M by the fuser 26. The feeding mechanism 24 feeds the recording medium M along a feeding path 28 to the image transfer member 22, the fuser 26, and a paper exit 30 sequentially, so as to complete printing process.

A conventional method for simplifying the assembly of the multi-function printer 10 is to modularize components inside the multi-function printer 10. That is, before being assembled as the multi-function printer 10, the components are integrated into modules, such as the image bearing member 16 and the image transferring member 22 being integrated as one single module. Thus, the assembly of the multi-function printer 10 can be quickly completed by assembling the integrated modules. However, the overall volume of the multi-function printer 10 is increased accordingly. Moreover, the modularized components cannot be separated from one another, causing a problem to users, for tools are needed to disassemble the multi-function printer 10 to clear the paper jammed between the nips of the image bearing member 16 and the image transferring member 22.

### SUMMARY OF THE INVENTION

The present invention provides an image processing device including a base, an upper casing liftably disposed over the base, an image bearing member mounted in the upper casing, and an image transfer member mounted in the base and positioned opposite the image bearing member. The image bearing member and the image transfer member transfer a toner image from the image bearing member to a recording medium passing therebetween. The image bearing member is removed from its position opposite the image transfer member as the upper casing is lifted from the base.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a perspective view of a multi-function printer according to the prior art.

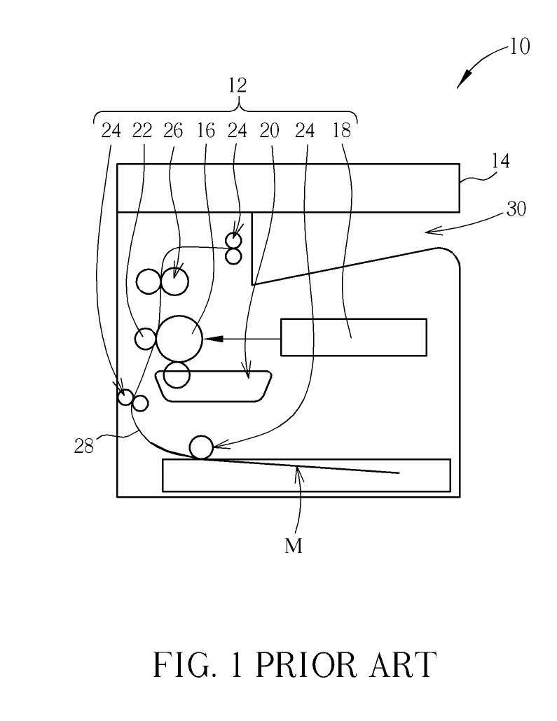

FIG. 2 is a pictorial view of an image processing device according to a preferred embodiment of the present invention, with an upper casing being detached from a base.

FIG. 3 is a pictorial view of the base of the image processing device in FIG. 2.

FIG. 4 is a pictorial view of the image processing device according to the preferred embodiment of the present invention.

FIG. 5 is a pictorial view of the image processing device in FIG. 4, with the upper casing being lifted from the base.

FIG. 6 is a pictorial view of an image processing device according to another preferred embodiment of the present invention.

FIG. 7 is a pictorial view of the image processing device in FIG. 6, with the upper casing being detached from the base.

### DETAILED DESCRIPTION

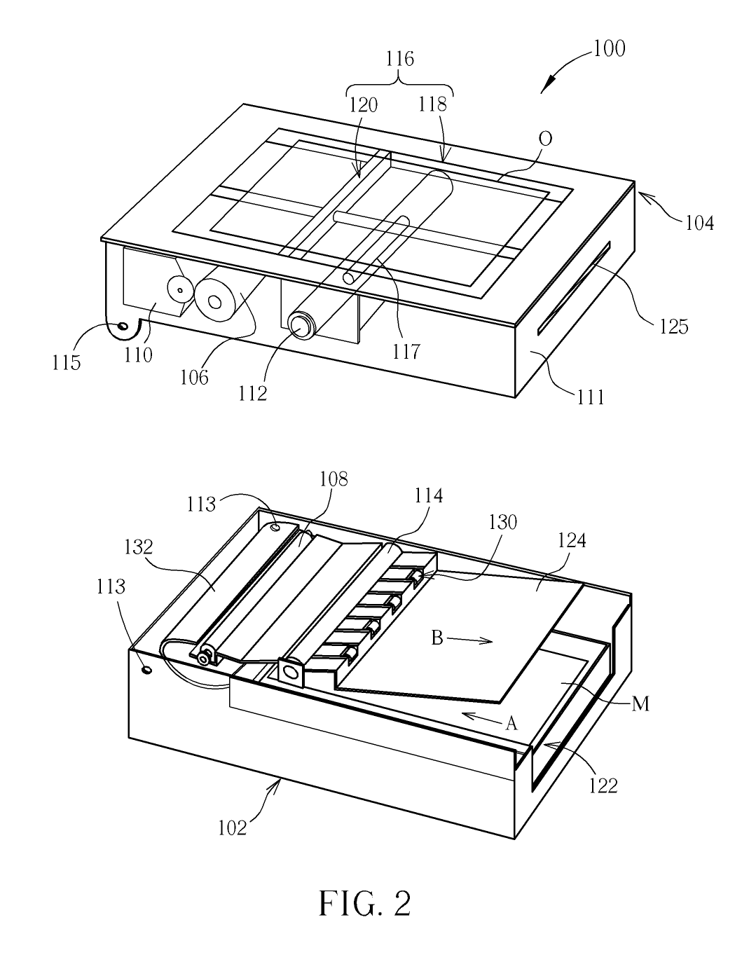

Please refer to FIG. 2, which is a pictorial view of an image processing device 100 according to a preferred embodiment of the present invention, with an upper casing being detached from a base. In this embodiment, the image processing device 100 is preferably a printing apparatus, such as a laser multi-function printer. As shown in FIG. 2, the image processing device 100 includes a base 102, an upper casing 104, an image bearing member 106 (e.g. a photosensitive drum), an image transfer member 108 (e.g. a transfer roller or a transfer belt) , a developing assembly 110, a first fusing member 112, a second fuser 114 and a scanner 116. Detailed description of the disposal of the said components is illustrated as follows. In order to clearly show the disposal of the components inside the upper casing 104, a side plate 111 of the upper casing 104 is depicted in a partial perspective view. The upper casing 104 is liftably disposed over the base 102. In this embodiment, the upper casing 104 is pivotally connected with the base 102 at one end, as shown in FIG. 2. In FIG. 2, the base 102 has at least one first pivot structure 113, and the upper casing 104 has a corresponding second pivot structure 115. A pivot pin (not shown in FIG. 2) is inserted through the first pivot structure 113 and the second pivot structure 115 to support the rotation of the upper casing 104 with respect to the base 102, so as to pivotally connect the upper casing 104 to the base 112.

The image bearing member 106, mounted in the upper casing 104, receives lights emitted from a laser or an LED light source (not shown) in the image processing device 100 and a corresponding latent image is thereby formed. The image transfer member 108 is mounted in the base 102 and positioned opposite the image bearing member 106. In this embodiment, the image transfer member 108 is a transfer roller. The image transfer member 108 and the image bearing member 106 cooperatively transfer a toner image from the image bearing member 106 to a recording medium M passing therebetween. The developing assembly 110 is mounted in the upper casing 104 and located at a side of the image bearing member 106. The developing assembly 110 supplies and adheres toners to the latent image of the image bearing member 106, so as to form the toner image. The first fusing member 112 is mounted in the upper casing 104, and the second fusing member 114 is mounted in the base 102 and positioned opposite the first fusing member 112. The first fusing member 112 and the second fusing member 114 cooperatively fix the toner image on the recording medium M. The image processing device 100 further includes a heat source 117 disposed in the upper casing 104 for heating the first fusing member 112 in order to melt the toners of the toner image. In this embodiment, the heat source 117 is installed in the first fusing member 112.

As shown in FIG. 2, the scanner 116 is mounted in the upper casing 104 and disposed above the image bearing member 106. The scanner 116 includes a platform 118 and an image capturing unit 120. The platform 118 loads an original sheet O, and the image capturing unit 120 captures an image of the original sheet O loaded on the platform 118. The image processing device 100 is capable of printing a scanned image of the original sheet O or output the scanned image to an external device, such as a computer or a USB flash drive (not shown). Thus, in addition to the above-mentioned printing function, the image processing device 100 has a scanning/copying function as well.

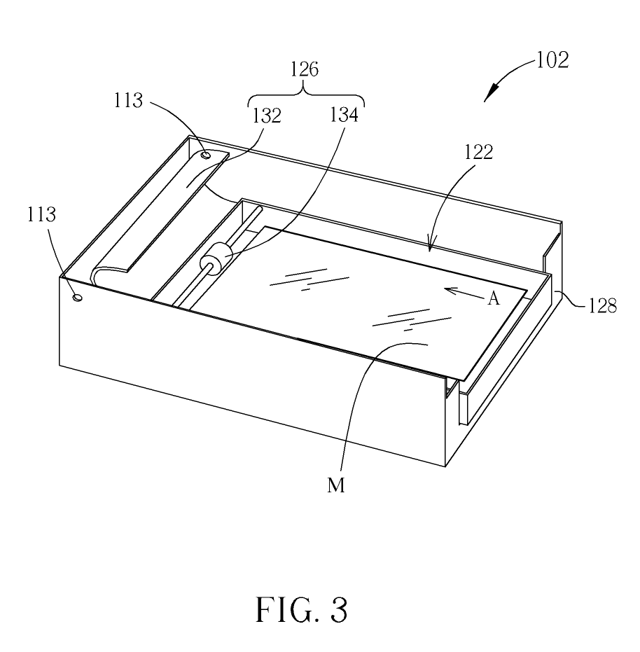

FIG. 3 is a pictorial view of the base 102 of the image processing device 100 in FIG. 2. Referring to FIG. 2 and FIG. 3, the image processing device 100 further includes an input cassette 122, an output tray 124 and a feeding mechanism 126. The input cassette 122 is disposed on a bottom portion 128 of the base 102 and stores at least one recording medium M, for example, a paper sheet. The input cassette 122 is preferably, but not limited to, a drawer-typed paper cassette. In this embodiment, the input cassette 122 is embedded on the bottom portion 128 of the base 102. The output tray 124 is mounted in the base 102 and disposed above the input cassette 122, and stores the processed recording medium M. As shown in FIG. 2, the feeding mechanism 126 includes a pickup roller 134, a paper guide 132 and an output roller 130. The feeding mechanism 126 is mounted in the base 102. The pickup roller 134 picks the recording medium M from the input cassette 122 and feeds it into a feeding path, and then the recording medium M is guided by the paper guide 132 to pass between the image bearing member 106 and the image transfer member 108, as well as pass between the first fusing member 112 and the second fusing member 114. Accordingly, the recording medium M is outputted from the output tray 124 via a paper exit 125 of the upper casing 104. The output roller 130 transmits the processed recording medium M to the output tray 124. As shown in FIG. 2, a feeding direction A of the recording medium M is opposite to a discharging direction B of the recording medium M.

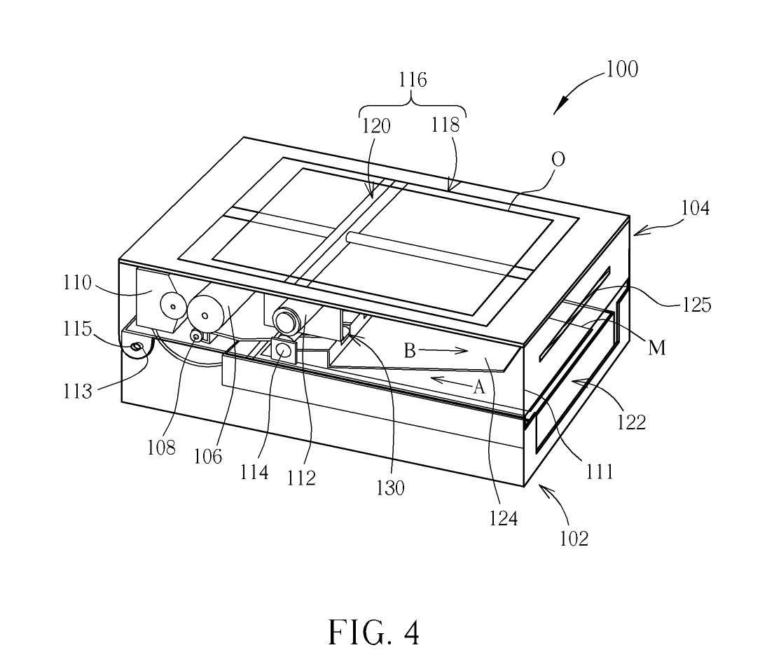

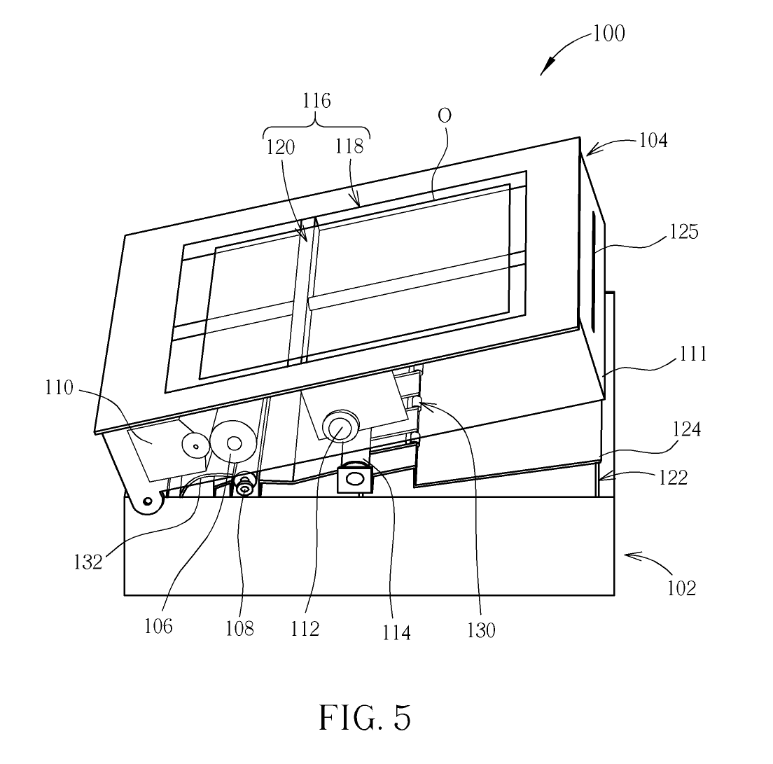

Please refer to FIG. 4 and FIG. 5. FIG. 4 is a pictorial view of the image processing device 100 according to the preferred embodiment of the present invention, and FIG. 5 is a pictorial view of the image processing device in FIG. 4, with the upper casing 104 being lifted from the base 102. If paper jam occurs during the printing process, that is, if the recording medium M is not appropriately fed and then stuck between the image bearing member 106 and the image transfer member 108, a user only needs to lift the upper casing 104. The upper casing 104 is rotated relatively to the base 102 from a position as shown in FIG. 4 to a position as shown in FIG. 5. Since the image bearing member 106 is mounted in the upper casing 104 and the image transfer member 108 is mounted in the base 102, during the said action the image bearing member 106 is removed from its position opposite the image transfer member 108 (as shown in FIG. 5). In such a manner, the recording medium M stuck between the image bearing member 106 and the image transfer member 108 can be pulled out easily to solve the paper jam problem. Afterwards, the upper casing 104 is pushed down relatively to the base 102 from the position shown in FIG. 5 back to the position shown in FIG. 4 to proceed to the subsequent printing steps.

In addition, if the recording medium M is stuck between the first fusing member 112 and the second fusing member 114, the user can clear the paper jam by lifting the upper casing 104 from the base 102 as well . As a result, the upper casing 104 can be rotated relatively to the base 102 from the position as shown in FIG. 4 to the position as shown in FIG. 5. Similarly, the first fusing member 112 is removed from the second fusing member 114 in synchronism with rotation of the upper casing 104. In such a manner, the recording medium M stuck between the first fusing member 112 and the second fusing member 114 can be pulled out easily to solve the paper jam problem.

Furthermore, the said scanner 116 is an omissible component for simplifying mechanical design of the image processing device 100. That is, the image processing device 100 can simply be a printer, without the scanner 116.

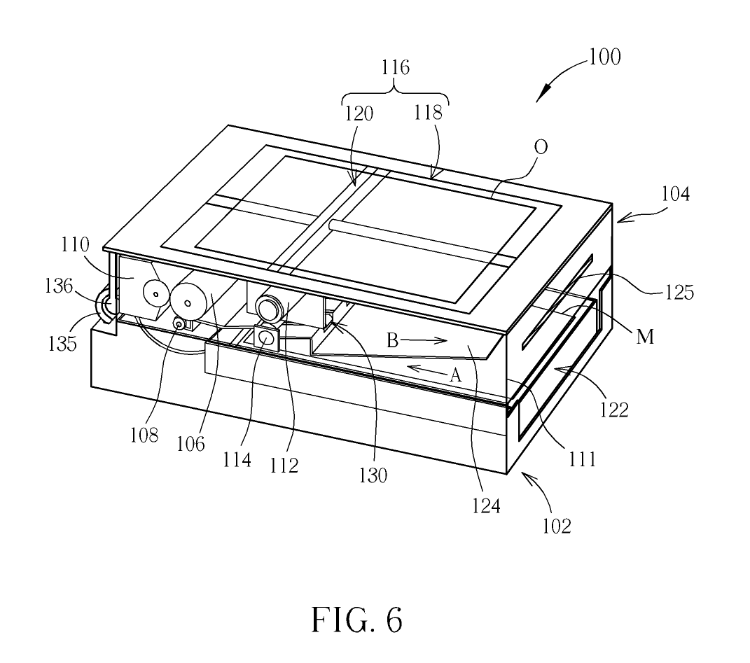

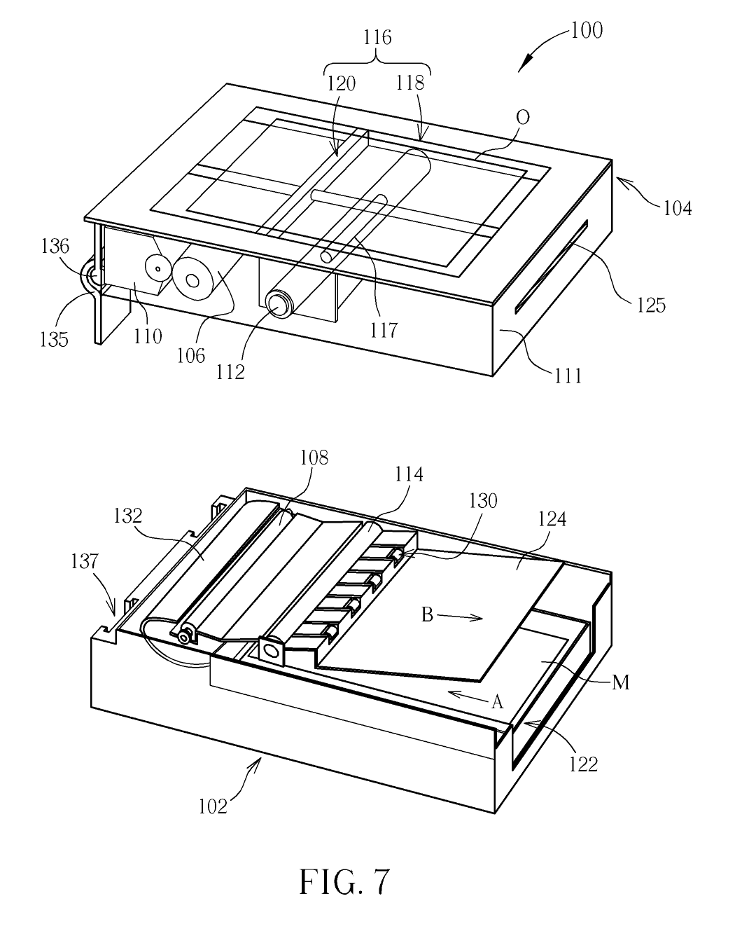

Furthermore, the connection of the base 102 and the upper casing 104 is not limited to the pivotal connection mentioned in the said embodiment, meaning that the image processing device 100 can also utilize other mechanism for engaging or disengaging the upper casing 104 and the base 102. FIG. 6 is a pictorial view of an image processing device 100 according to another preferred embodiment of the present invention. FIG. 7 is a pictorial view of the image processing device 100 in FIG. 6, with the upper casing 104 being detached from the base 102. As shown in FIG. 6 and FIG. 7, a hinge member 135 (two shown in this embodiment) is detachably disposed in a corresponding slot 137 of the base 102 as shown in FIG. 7. The upper casing 104 has a corresponding pivot shaft 136. The hinge member 135 is engaged with the pivot shaft 136 to enable the rotation of the upper casing 104 relative to the base 102. Similarly, if paper jam occurs during the printing process, the user can lift the upper casing 104 from the base 102 or unplug the hinge member 135 from the slot 137. Accordingly, the image bearing member 106 is removed from its position opposite the image transfer member 108 (as shown in FIG. 7). In such a manner, the recording medium M stuck between the image bearing member 106 and the image transfer member 108 can be pulled out easily. Afterwards, the hinge member 135 can be inserted into the slot 137 again to restore the upper casing 104 to its position above the base 102 (as shown in FIG. 6) to proceeding to the subsequent printing steps. As for which design is utilized, it depends on practical demands.

Those skilled in the art will readily observe that numerous modifications and alterations of the device and method may be made while retaining the teachings of the invention.

What is claimed is:

1. An image processing device comprising:
a base;
an upper casing liftably disposed above the base;
an image bearing member mounted in the upper casing; and
an image transfer member mounted in the base and positioned opposite the image bearing member, wherein the image bearing member and the image transfer member transfer a toner image from the image bearing member to a recording medium passing therebetween;
wherein the image bearing member is removed from its position opposite the image transfer member as the upper casing is lifted from the base.

2. The image processing device of claim 1, wherein the upper casing is pivotally connected with the base.

3. The image processing device of claim 1, wherein the upper casing is detachably disposed over the base.

4. The image processing device of claim 1 further comprising:
a first fusing member mounted in the upper casing; and
a second fusing member mounted in the base and positioned opposite the first fusing member, wherein the first fusing member and the second fusing member fix the toner image on the recording medium and the first fusing member is removed from its position opposite the second fusing member as the upper casing is lifted from the base.

5. The image processing device of claim 4 further comprising:
a heat source disposed in the upper casing for heating the first fusing member so as to melt toners of the toner image.

6. The image processing device of claim 1 further comprising:
a developing assembly unit mounted in the upper casing and located at a side of the image bearing member.

7. The image processing device of claim 1 further comprising a scanner mounted in the upper casing and disposed above the image bearing member, the scanner comprising:
a platform loading an original sheet; and
an image capturing unit capturing an image of the original sheet loaded on the platform.

8. The image processing device of claim 1 further comprising:
an input cassette, disposed on a bottom portion of the base, storing the recording medium;
an output tray mounted in the upper casing and disposed above the input cassette, storing the processed recording medium; and
a feeding mechanism, mounted in the base, feeding the recording medium from the input cassette to the output tray through the image bearing member.

9. The image processing device of claim 8, wherein a feeding direction of the recording medium is opposite to a discharging direction of the recording medium.

10. The image processing device of claim 8, wherein the input cassette is a drawer-typed paper cassette.
